(19) United States
(12) Patent Application Publication
(10) Pub. No.: US 2025/0346302 A1
(43) Pub. Date: Nov. 13, 2025

(54) HOT DIP GALVANIZATION OF DECK ASSEMBLY COMPONENTS

(71) Applicants: Christian S. Lee, Pooler, GA (US); Timothy D. Miller, Guyton, GA (US); Richard D. McCombs, Savannah, GA (US)

(72) Inventors: Christian S. Lee, Pooler, GA (US); Timothy D. Miller, Guyton, GA (US); Richard D. McCombs, Savannah, GA (US)

(21) Appl. No.: 18/660,051

(22) Filed: May 9, 2024

(51) Int. Cl. B62D 25/20; C23C 2/06

(52) U.S. Cl. CPC B62D 25/2054; C23C 2/06

(57) ABSTRACT

A deck assembly for a truck body of a vehicle is provided. The deck assembly is formed by a process. This process comprises hot dip galvanizing a first component that comprises metal, comprises hot dip galvanizing a second component that comprises metal, and attaching the first component and the second component together using fasteners. When the first component and the second component are attached together using fasteners, the components are not attached together using welds. Hot dip galvanization may result in the deposition of material comprising zinc onto the first component and the second component to prevent corrosion in the first component and the second component. All metal components of the deck assembly may be hot dip galvanized separately and then fastened together.

### FIELD

Embodiments relate generally to hot dip galvanization approaches for components of a deck assembly on a vehicle.

### BACKGROUND

Corrosion may lead to deterioration in metal properties over time. Corrosion can, for example, compromise metal appearance, performance, and strength. Protection against corrosion has been provided in a variety of ways, for example, by spraying or painting protective coatings on metal surfaces and applying undercoatings. Electroplating, electroless plating, and mechanical plating of metals have also been used.

Galvanization is a process of applying a zinc coating to ferrous metals to protect against rust. The coating may be applied, for example, by methods such as hot-dip galvanization, spray galvanization, and electroplating. Hot-dip galvanization provides a protection layer that is thicker than that of the other two methods and is well known in automotive and other applications in which the galvanized product will be used in possibly harsh environments. While welding of galvanized metals is possible, precautions usually taken during the process sometimes discourage such methods, so that components of an assembly made of steel or other ferrous material are instead welded together into the full assembly prior to galvanization. Thus, when hot-dip galvanizing, the assembled device is dipped into a galvanization vat that is large enough to accommodate the assembly as a whole.

The present invention may recognize and address one or more considerations of prior art constructions and methods, as recited above or otherwise.

### BRIEF SUMMARY

In one or more embodiments of the present invention, hot dip galvanization is used to provide protection for a deck assembly of a truck body in a vehicle. Hot dip galvanization may be performed for individual metal components of the deck assembly so that the individual metal components may each fit within a vat having a relatively small size. Alternatively, hot dip galvanization may be performed for multiple sets of metal components from the deck assembly, and the sets of metal components may be positioned in a vat so that hot dip galvanization may be performed. After components or sets of components have been hot dip galvanized, these components or sets of components may be attached together using fasteners rather than being welded together.

In hot dip galvanization, component(s) are coated with a material comprising zinc to protect against corrosion. Component(s) may be positioned in a vat holding molten material comprising zinc. Embodiments described herein may allow a smaller vat to be used, allowing manufacturing to be completed in a cost-effective manner. Additionally, even where a deck assembly has a unique shape, the deck assembly may be broken down into smaller components or sets of components so that the hot dip galvanization may be performed. Thus, a single vat may be used rather than multiple vats.

In an embodiment of a deck assembly for a vehicle, the deck assembly is formed by a process in which a first component is hot dip galvanized, the first component comprising metal. A second component is hot dip galvanized, the second component comprising metal. The first component and the second component are attached together using fasteners, wherein the first component and the second component are not attached together via welds.

In another embodiment of a method of manufacturing a vehicle, a vehicle chassis frame, a plurality of front wheels and a plurality of rear wheels disposed on the chassis frame via a suspension, a drive train mounted on the chassis frame and operatively attached to the rear wheels, and a driver cab disposed on a forward end of the chassis frame are provided. A plurality of components of a deck assembly of a cargo body comprising at least one cross member and at least one longitudinal member transverse to the at least one cross member are hot dip galvanized, wherein the components of the plurality of components are unattached with respect to each other during the step of hot dip galvanizing the plurality of components. Following the hot dip galvanizing step and in a step of assembling the deck assembly, the components of the plurality of components are attached into the deck assembly with fasteners that extend through or into the components of the plurality of components. The deck assembly is assembled onto the vehicle chassis frame rearward of the driver cab. The cargo body is assembled onto the deck assembly, where the cargo body comprises a plurality of walls, a roof, and a floor, and wherein the floor is mounted onto the deck assembly.

In a still further embodiment of a method for manufacturing a deck assembly for a vehicle, a first component is hot dip galvanized, the first component comprising metal. A second component is hot dip galvanized, the second component comprising metal. The first component and the second component are attached together using fasteners, wherein the first component and the second component are not attached together via welds.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a schematic illustration of a cargo vehicle, in accordance with an embodiment of the present invention;

FIG. 2 is a partial top schematic illustration of the cargo vehicle as illustrated in FIG. 1, omitting the cargo enclosure roof;

FIG. 3 is an exploded view illustrating an example deck assembly, in accordance with an embodiment of the present invention;

FIG. 4 is an exploded view illustrating an example deck assembly, in accordance with an embodiment of the present invention;

FIG. 5 is a flow chart illustrating an example method for manufacturing a deck assembly of a vehicle, in accordance with an embodiment of the present invention; and

FIG. 6 is a flow chart illustrating an example method for manufacturing a deck assembly of a vehicle, in accordance with an embodiment of the present invention.

Repeat use of reference characters in the present specification and drawings is intended to represent same or analogous features or elements of the invention according to the disclosure.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present disclosure covers such modifications and variations as come within the scope of the appended claims and their equivalents. All values indicated below are intended to be approximated values.

It should be understood that terms of orientation, e.g., “forward,” “rearward,” “upper,” “lower,” and similar terms as used herein are intended to refer to relative orientation of components of the devices described herein with respect to each other under an assumption of a consistent point of reference but do not require any specific orientation of the overall system. Thus, for example, the discussion herein may refer to the “forward,” “rearward,” “lateral,” “side,” or similar descriptions, referring to areas of or directions with respect to a vehicle. Such terms may be used in the present disclosure and claims and will be understood to refer to a relative orientation but not to an orientation of a claimed device with respect to an external frame of reference.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

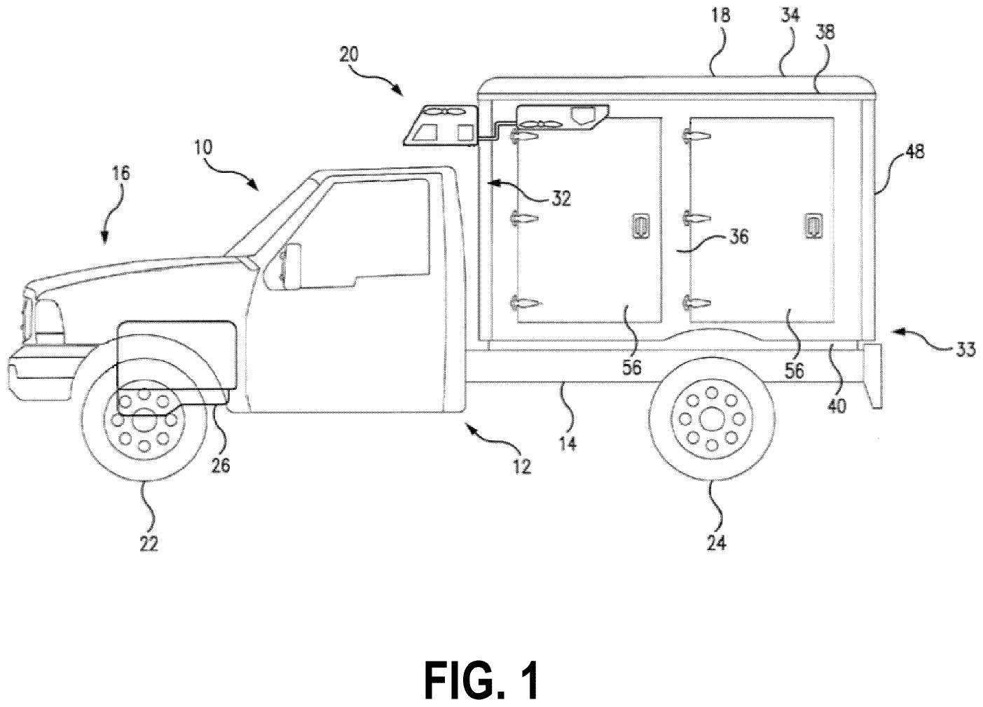

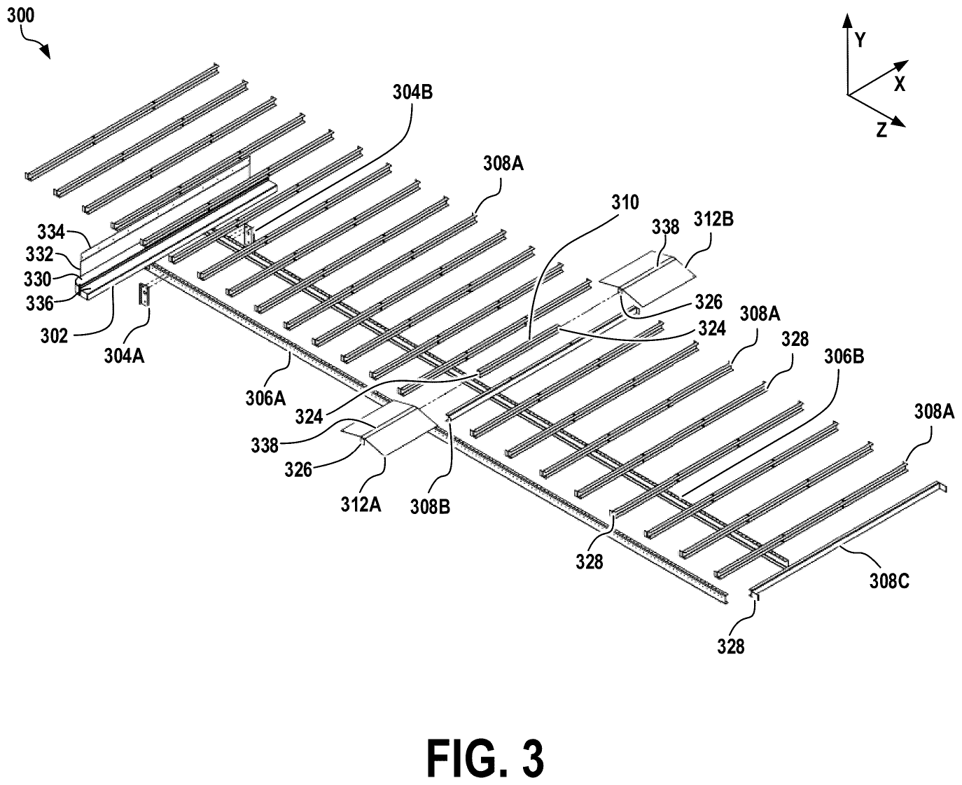

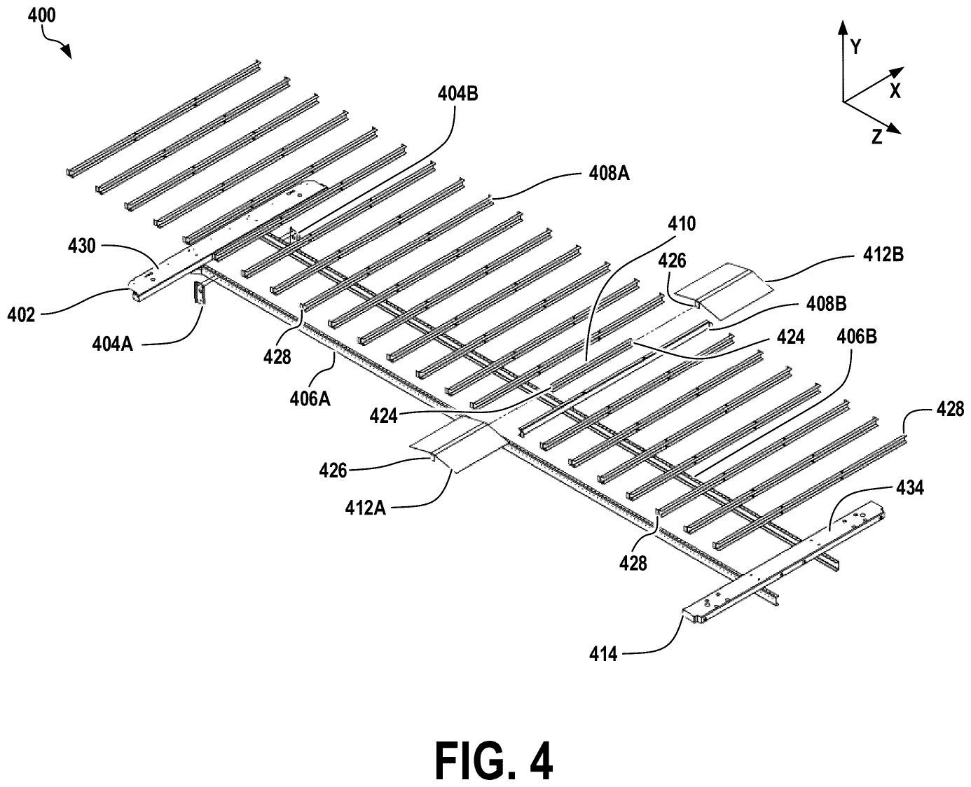

Referring to FIG. 1, a vehicle 10 includes a chassis assembly 12 having a ladder-type chassis frame 14, a cab body 16 mounted on chassis frame 14, and an enclosed cargo compartment body 18. Cargo compartment body 18, in one or more embodiments, comprises insulated walls, a floor mounted onto a deck assembly (see FIGS. 3 and 4) under the floor, and a roof to thereby define an insulated interior cargo volume cooled by a refrigeration system 20 mounted to body 18. The deck assembly, which may be considered separate from or part of body 18, in either case provides the bottom structural support for body 18 and is positioned between chassis frame 14 and the structural or non-structural floor of body 18. The deck assembly may be, in one or more embodiments, mounted to chassis frame 14, thereby mounting cargo compartment body 18 to the chassis frame, with the floor being mounted on the deck assembly. The deck assembly may be, for example, constructed as described herein with regard to deck assembly 300 of FIG. 3 or deck assembly 400 of FIG. 4, but it should be understood that other deck assemblies may also be utilized and that the assemblies of FIGS. 3 and 4 are provided for example only.

Vehicle 10 also includes a suspension system, a drive train system, and a steering system. In one or more embodiments, the suspension system comprises a plurality of (in this instance, two) front wheels, wheel hubs, and corresponding tires 22, a plurality of (in this instance, four) rear wheels, wheel hubs, and corresponding tires 24, an axle assembly extending underneath and across the truck between individual wheels (in the front) or pairs of wheels (in the rear) that oppose each other on opposite sides of the truck, leaf springs that connect the axle assemblies to each of the two painted steel elongated C beams that comprise ladder-type chassis frame 14, shock absorbers connecting the leaf springs or hubs to the frame, and associated torque rods, bolts, bushings, and stabilizers. It should be understood that various types of suspension systems may be employed, for example including airbags. The drive train comprises an engine 26 mounted in an engine bay of cab body 16, a rear differential and drive axles that connect the rear differential to the wheel hubs, a longitudinal drive axle, and a transmission that translates the driving rotation from the engine crank shaft to the rear differential through the longitudinal drive axle.

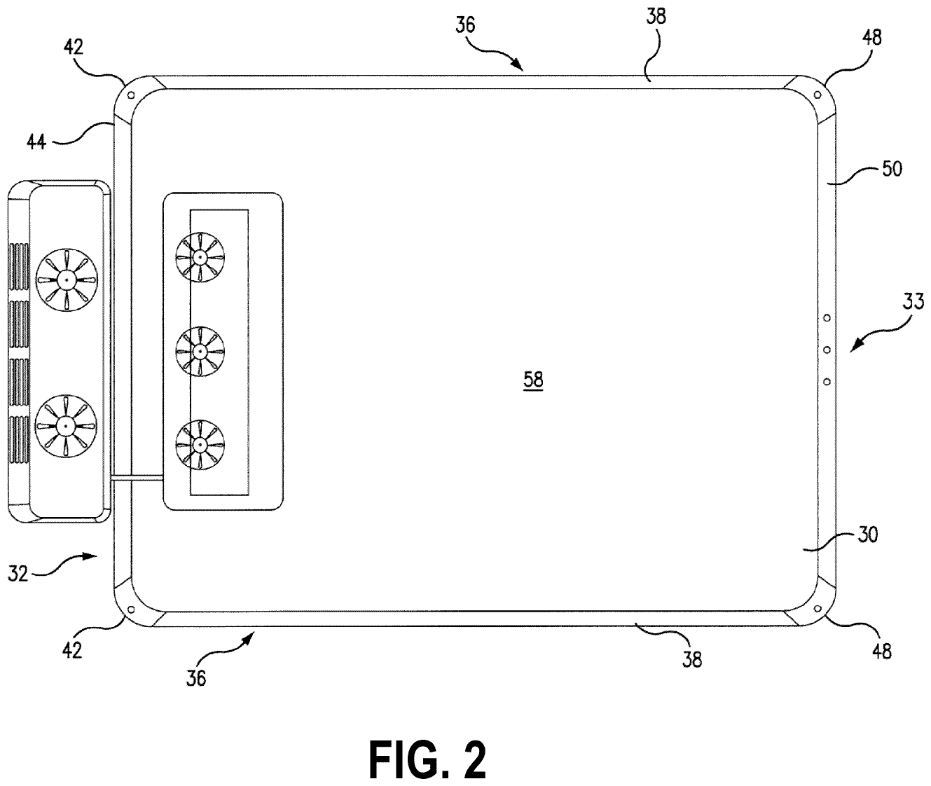

As illustrated in FIGS. 1 and 2, cargo compartment body 18 is comprised of a floor 30, a front wall 32, a rear wall 33, a roof 34, and two opposing side walls 36. Cargo compartment body 18 also comprises two opposing aluminum side top rails 38 that extend longitudinally along the cargo compartment body and attach respective side walls 36 to roof 34, as well as two opposing aluminum side bottom rails 40 that extend longitudinally (parallel to the vehicle's front-to-back dimension) along the cargo compartment body and attach respective side walls 36 to the deck assembly, and thereby floor 30, as described herein. Openings with corresponding doors 56 are positioned through side walls 36 to allow access to volume 58. A pair of opposing steel front posts 42 extend vertically between and connect respective side walls 36 to front wall 32. An aluminum front top rail 44 extends transversely to the vehicle's longitudinal dimension between front posts 42 and connects front wall 32 to roof 34. An aluminum front bottom rail (not shown), generally parallel to front top rail 44, connects front wall 32 to floor 30 and the deck assembly. Front posts 42 may be vertical and may connect to side bottom rails 40, side top rails 38, front top rail 44, and the front bottom rail, forming part of the body frame that holds together the side walls, floor, front wall, and roof. Similarly, a pair of opposing steel vertical rear posts 48, aluminum rear top rail 50 (see FIG. 2), and a steel rear bottom rail or sill (not shown) connect the side walls, roof, and floor at the vehicle's rear and connect two side top rails 38 and side bottom rails 40 to complete the body frame. A rear wall panel (in one or more discrete sections) may attach to the rear frame, comprised of vertical rear posts 48, rear top rail 50, and the rear bottom rail or sill. A rear wall panel, if present (the rear opening may, e.g., instead be entirely or partially filled by doors) may be continuous or may define one or more openings that receive and enclose one or more rear doors (not shown) that are of a size and that hingedly attach to the rear panel or the rear vertical posts so that, when closed, the rear panel and doors completely close the space bounded by the rear frame. Floor 30 may also have a variety of configurations and may, for example, comprise a generally planar wooden, polymer, or aluminum top floor sheet covering an insulation material and supported underneath by transverse cross members of the deck assembly that attach at their respective ends to side bottom rails 40. Each of side walls 36 may be constructed of an inner fiber reinforced polymer (FRP) panel and an exterior FRP panel separated by a welded steel frame fitted with wooden or foam spacers (between the side wall frame and the inner and exterior panels) to reduce thermal conductivity and enclose the inner volume between the panels. That inner volume is then injected with foam resins that expand, harden, and cure, adhering to the inner and exterior panels and framing to produce, together, a rigid structural wall panel. Each side wall, front wall, roof and rear wall are, in one or more embodiments, similarly constructed and are assembled to form, with the deck assembly and side and/or rear doors, a box mounted on chassis frame 14 behind vehicle cab body 16. In some embodiments, the box may be a refrigerated box, but it should be understood that the box need not be insulated or refrigerated in other embodiments (and, in such embodiments, not have insulation in the walls, roof, and flooring). In view of the present disclosure, it should be understood that the vehicle structure may vary. For instance, the wall structures may be formed in a foam-insulated sheet-and-post construction, particularly in longer, semi-trailer/tractor vehicles. Thus, it should be understood that the vehicle structures specifically discussed herein are solely for purposes of example and are not presented for purposes of limitation of the present disclosure.

In one or more embodiments, the side top rails, side bottom rails, front and rear top rails, and front bottom rails are made from aluminum. In one or more other embodiments, these components are made of other suitable materials, such as steel. In one or more embodiments, the steel vertical posts 42 and 48, and steel rear sill, may be galvanized, as discussed herein, but in one or more other embodiments may be painted, without galvanization.

Volume 58 (see FIG. 2) may be a single, undivided volume or may be, for example, divided into sub-volumes by interior walls or panels so that there is no air flow communication between the sub-volumes, of which there may be two or three. The sub-volumes may be used, for example, to maintain different temperature regions.

Deck assemblies having components that are galvanized through hot dip galvanization are also contemplated. Referring to FIG. 3, one or more examples of a deck assembly 300 form a portion of a body (such as of body 18, FIG. 1, in this example used for dry freight) of a vehicle. Deck assembly 300 comprises a steel front channel 302 that generally extends, in its dimension of elongation, parallel to the X dimension indicated in FIG. 3 (transverse to the vehicle's longitudinal front-to-back dimension, as indicated by the Z dimension in FIG. 3). A first elongated steel bottom beam 306A and a second elongated steel bottom beam 306B attach to front channel 302 by respective flanges (not shown in FIG. 3) that extend vertically down from a bottom surface of front channel 302. Beams 306A and 306B are generally C-shaped, with the “C” of each beam opening inward, toward the floor center. The two vertical flanges extending down from front channel 302 respectively abut flush with the back outward vertical surface of the “C” of each beam. Each flange defines two horizontal holes that align with corresponding horizontal holes through the vertical portion of the beam 306A or 306B against which it abuts. Bolts extend horizontally through the holes in the flanges and the beams to secure front channel 302 to the forward ends of the beams.

Front channel 302 provides structural support for the front wall of body 18. The bottom end of the body's front wall rests on a forward ledge 330 of front channel 302. A plate 332 is attached to the front wall by rivets or bolts extending through a plurality of through holes in an upper band 334 of plate 332 and into the front wall. Plate 332 defines a parallel row of through holes in a lower band (not visible in FIG. 3) through which a plurality of rivets or screws extend and into a forward face of channel 302, thereby securing the front wall to the front channel. A forward edge of the flooring extends onto a rearward ledge 336 that is slightly below forward ledge 330, so that the vertical surface extending between the two ledges defines a stop for the floor sheeting.

Beams 306A and 306B extend in their elongated dimension parallel to the Z-axis (the vehicle's, and thus the beams', front-to-back dimension) as shown in FIG. 3. In one or more embodiments, a plurality of steel mounting brackets 304A (one of which is shown in FIG. 3) are bolted (with a pair of bolts for each mounting bracket) to the flat back side of the “C” of beam 306A, with the mounting brackets spaced apart in the Z dimension along the beam's length. A plurality of mounting brackets 304B (one of which is shown in FIG. 3) are similarly bolted to and spaced apart along the flat back side of the “C” of second beam 306B. Bottom beams 306A and 306B are spaced apart from each other, in the X dimension as shown in FIG. 3, by an offset corresponding to an offset of the parallel C beams of chassis frame 14 (FIG. 1) with respect to each other, so that the outward edges of beams 306A and 306B (in one or more embodiments, the flat back surface of the “C” in each case) are flush with the respective outward-facing (away from the vehicle's longitudinal center dimension, which is parallel to the Z dimension in FIG. 3) surfaces of the vehicle chassis's C beams and so that the bottom portions of mounting brackets 304A seat against the outward surface of the vehicle chassis 14 (FIG. 1) C beam that is beneath the bottom beam 306A and so that the bottom portions of mounting brackets 304B seat against the outward surface of the vehicle chassis C beam that is beneath the bottom beam 306B. By bolting each mounting bracket (e.g., using a single bolt, which is of a larger diameter than the two upper bolts that attach the bracket to its deck assembly bottom beam 306A or 306B), mounting brackets 304A, 304B connect deck assembly 300 (and, thereby, body 18) to chassis frame 14 (FIG. 1). Through holes may be provided in each of the vehicle chassis C beams, mounting brackets 304, and bottom beams 306 so that the holes in the mounting brackets align with correspondingly arranged and dimensioned holes through bottom beams 304 and the vehicle frame beams to facilitate the bolted attachment of the brackets to those structures.

Deck assembly 300 includes various steel cross members, in one or more embodiments such as cross members 308A, cross member 308B, cross member 308C, and a cross member 310, that are elongated and that are disposed in the deck assembly with their dimensions of elongation generally parallel with each other (generally parallel to the X dimension in FIG. 3), and in the cross members' dimension of elongation are generally transverse to the vehicle's (and its chassis frame's C beams') dimension of longitudinal elongation (in the Z or front-to-back dimension, in FIG. 3). Cross members 308A, 308B, and 308C also each define holes extending vertically (in a dimension parallel to dimension Y in FIG. 3) through cross members 308A, 308B, 308C through which bolts, screws, or other fasteners may extend to connect cross members 308A, 308B, 308C to bottom beams 306A, 306B. In each cross member, these holes are spaced apart in a dimension parallel to the X dimension so that each cross member defines a plurality of pairs of holes spaced apart by the same distance as two vertical through holes respectively in the top flanges (and bottom flanges) of the “C” of bottom beams 306A and 306B (that are aligned with each other in the X dimension) are spaced apart from each other in the X dimension. Bottom beams 306A and 306B each defines a plurality of these vertical holes spaced apart from each other in the Z dimension at regular intervals so that the plurality of cross members 308A, 308B, 308C, and 310 may be spaced apart from each other in the Z dimension by, e.g., a common spacing and each may be secured by fasteners to the bottom beams. Tabs 328 extending from respective opposite ends of each cross member are disposed flush against the interior surface of side bottom rails 40 (FIG. 1). Rivets or screws extend through holes in tabs 328 and the side bottom rails to thereby secure the deck assembly cross members to the side walls.

Cross member 310 defines a length extending in the X dimension that is shorter than the lengths of cross members 308A, 308B, 308C extending in the X dimension. Steel plate covers 312A, 312B are attached to cross member 310 at each end of cross member 310 through a bolted attachment of tabs 326 extending downward (in the Y dimension) from the apex of the generally planar plate flanges to respective tabs 324 extending forwardly (in the Z dimension) from the vertical portion of the “C” of cross member 310. Covers 312A, 312B attach to respective side bottom rails 40 (FIG. 1) by bolts extending through the side rails and respective downward-extending tabs 326 on the opposite (outward from the deck center, in the X dimension) sides of covers 312A, 312B that sit flush against the side bottom rails. Each plate defines a downward-facing concave structure to provide adequate clearance for the vehicle rear wheels. In some embodiments, covers 312A, 312B may also slide into openings defined in adjacent cross members 308A, 308B to assist in maintaining the position of covers 312A, 312B. These and any other connections in deck assembly 300 may be made using fasteners such as bolts, rivets, or screws, and such fasteners may be considered part of deck assembly 300. As referenced herein, a fastener is a discrete mechanical structural component used to attach two or more other discrete components of a mechanical assembly together. Thus, it will be understood that a weld is not a fastener.

As discussed below, each of the deck assembly cross members is formed in a “C” shape cross section in a vertical plane that includes the Z dimension. For most of the cross members, identified in FIG. 3 as 308A, the C shape opens toward the vehicle rear, with the flat back surface of the “C” facing forward and generally planar upper and lower flanges extending rearward from the vertical portion. Two cross members, however, are in the reverse orientation and are referenced as 308B and 308C in FIG. 3. Cross member 308B is immediately aft of steel plate covers 312A and 312B, resulting in a cross member 308A, with its concave cross section opening toward the steel plate covers, forward of the steel plate covers and a cross member 308B, with its concave cross section also opening toward the steel plate covers, rearward of the steel plate covers. This allows the side edges (extending parallel to the X dimension in FIG. 3) of steel plate covers 312A and 312B to be received within the two cross members' concave openings. In one or more embodiments, the broad generally planar side flanges of each steel plate cover on the two sides of the steel plate cover's center ridge have to bend slightly downward to be received in these cross-member concave openings, thus causing those sides to be biased upward against the cross member top flanges. In one or more embodiments, the side edges of the plates are not attached to these cross members by fasteners or welding.

Cross member 308C is the rearmost cross member in the deck assembly. Its concave opening faces forward so that each of its end tabs 328 can extend into the rear sill (not shown) and against a flat surface thereof. At each tab, one or more horizontally aligned bolts extend through the tab and into the rear sill flat surface, thereby attaching the rear sill, and thereby the rear frame, to the deck assembly. The end tabs of cross member 308C are longer than the end tabs of the other cross members 308 so that they can reach sufficiently into the rear sill to allow the cross member's connection to the rear sill. The rear sill also rests on the rearward ends of longitudinal beams 306A and 306B and attaches to the top flanges of those beams by through bolts. A wood, composite, or aluminum floor sheet is disposed on top of the cross members, and screws are driven through the floor sheet into premade holes in the cross members' top flanges, thereby securing the floor to the deck assembly.

FIG. 4 illustrates another example deck assembly 400 that forms a portion of a body (such as of a refrigerated body 18, FIG. 1) of a vehicle. Deck assembly 400 comprises a steel front channel 402 at a forward end of deck assembly 400 and a steel rear channel 414 at the deck assembly's rearward end. Each channel member 402, 414 generally extends, in its dimension of elongation, parallel to the X dimension indicated in FIG. 4 (transverse to the vehicle's longitudinal front-to-back Z dimension). First and second elongated steel bottom beams 406A and 406B are generally C-shaped, with the “C” opening inward, toward the floor center, and extend in their dimension of elongation parallel to the Z-axis as shown in FIG. 4. First and second elongated steel bottom beams 406A and 406B attach to front channel 402 by respective flanges (not shown in FIG. 4) that extend vertically down from a bottom surface of front channel 402 and that seat flush against the outward-facing back surfaces of the generally planar vertical sections of the “C” shaped beams. Similarly, first and second elongated steel bottom beams 406A and 406B attach to rear channel 414 by respective flanges (not shown in FIG. 4) that extend vertically down from a bottom surface of rear channel 414 and that seat flush against the outward-facing back surfaces of the generally planar vertical sections of the “C” shaped bottom beams. The vertical flanges from the front and rear channels attach to the deck assembly bottom beams by bolts in the same manner as discussed above with respect to front channel 302 of FIG. 3.

Front channel 402 bounds the front end of deck assembly 400, while channel 414 bounds the rear end. Unlike channel 302 and cross member 308C in the dry freight example of FIG. 3, channels 402 and 414 do not directly attach to the front or rear body wall. A polymer sheet not shown) covers the channels and cross members (discussed below). A sill made of a composite material is disposed on each cross member, and one or more screws are driven through each sill, through the sheet, and into premade holes in the top flanges of the cross members. An aluminum floorboard is disposed on top of the sills and screwed into the sills, thereby affixing the floor to the deck assembly. The floor is attached to the front and rear walls, thereby attaching the floor, and thereby the deck assembly, to the front and rear walls. The rear frame rear sill sits on the rearward ends of longitudinal beams 406A and 406B and is attached thereto by bolts. The rear sill covers rear channel 414 and the gap between the rear channel and the floor. Similarly, the front bottom rail covers the front of front channel 402 and the gap between the front channel and the floor.

In one or more embodiments, the gap between the plastic sheet and the floor is used to convey electrical conduit. The rear frame, for example, supports lighting, and there may be other electrical loads, for example a refrigeration unit, that require power, which is generally provided from the batteries or an alternator at the forward end of the vehicle. Thus, electrical wires, and surrounding conduit, extend from the forward power source to the rear end electrical loads. In the embodiments discussed above with regard to FIG. 3, electrical conduit extends from front to back of the cargo body, through the roof. In the one or more embodiments of FIG. 4, however, electrical conduit extends from front channel 402 to rear channel 414, through the gap between the polymer sheet and the floor panel. Through holes extend from the bottom of each of front and rear channels 402 and 414 and through top surfaces 430 and 434. Electrical wiring from a battery or alternator at the forward end of the vehicle extends up through one or more holes in front channel 402 and into one or more conduits in the floor, through the one or more conduits, through the holes in rear channel 414 and on to the destination electrical loads. After running the wiring, foam is injected into the gap between the polymer sheet and the floor panel, thereby establishing an insulated floor.

In one or more embodiments, a plurality of steel mounting brackets 404A (one of which is shown in FIG. 4) are bolted (with a pair of bolts for each mounting bracket) to the flat side of the “C” of beam 406A, with the mounting brackets spaced apart in the Z dimension along the beam's length. A plurality of mounting brackets 404B are similarly bolted to and spaced apart along the flat backside of the “C” of second beam 406B. Bottom beams 406A and 406B are spaced apart from each other, in the X dimension as shown in FIG. 4, by an offset corresponding to an offset of the parallel C beams of chassis frame 14 (FIG. 1), so that the outward edges of beams 406A and 406B (in one or more embodiments, the flat back surface of the “C” in each case) are flush with the respective outward-facing (away from the vehicle's longitudinal center dimension, which is parallel to the Z dimension in FIG. 4) surfaces of the vehicle chassis's C beams and so that the bottom portions of the mounting brackets 404A and 404B seat against the outward surface of the vehicle chassis C beam that is beneath the bottom beam 404A and 404B to which the mounting brackets are attached. By bolting each mounting bracket (e.g., using single bolt, which is of a larger diameter than the two upper bolts that attach the bracket to its deck assembly bottom beam 406A or 406B), mounting brackets 404A, 404B connect the deck assembly 400 (and, thereby, insulated body 18) to chassis frame 14 (FIG. 1). Through holes may be provided in each of the vehicle chassis C beams, mounting brackets 404, and bottom beams 406 so that the holes in the mounting brackets align with correspondingly arranged and dimensioned holes through bottom beams 404 and the vehicle frame beams to facilitate the bolted attachment of the brackets to those structures.

Deck assembly 400 include various steel cross members, in one or more embodiments such as cross members 408A, cross members 408B, and a cross member 410 that are elongated and that are disposed in the deck assembly with their dimensions of elongation generally parallel with each other (generally parallel to the X dimension in FIG. 4), and in the cross members' dimension of elongation are generally transverse to the vehicle's (and its chassis frame's C beams') dimension of longitudinal elongation (in the Z or front-to-back dimension, in FIG. 4). Cross members 408A, 408B also each define holes extending vertically (in a dimension parallel to dimension Y in FIG. 4) through cross members 408A, 408B through which bolts, screws, or other fasteners may extend to connect cross members 408A, 408B to beams 406A, 406B. In each cross member, these holes are spaced apart in a dimension parallel to the X dimension so that each cross member defines a plurality of pairs of holes spaced apart by the same distance as two vertical through holes respectively in the top flanges (and bottom flanges) of the “C” of bottom beam 406A and 406B (that are aligned with each other in the X dimension) are spaced apart from each other. Bottom beams 406A and 406B each defines a plurality of these vertical holes spaced apart from each other in the Z dimension at regular intervals so that the plurality of cross members 408A, 508B, and 410 may be spaced apart from each other in the Z dimension by, e.g., a common spacing and each may be secured by fasteners to the bottom beams. Tabs 428 extending from respective opposite ends of each cross member are disposed flush against the interior surface of side bottom rails 40 (FIG. 1). Rivets or screws extend through holes in tabs 428 and the side bottom rails to thereby secure the deck assembly cross members to the side walls.

Cross member 410 defines a length extending in the X dimension that is shorter than the lengths of cross members 408A, 408B extending in the X dimension. Steel plate covers 412A, 412B are attached to cross member 410 at each end of cross member 410 through a bolted attachment of tabs 426 extending downward (in the Y dimension) from the apex of the generally planar plate flanges to respective tabs 424 extending forwardly (in the Z dimension) from the vertical portion of the “C” of cross member 410. Covers 412A, 412B attach to respective side bottom rails 40 (FIG. 1) by bolts extending through the side rails and respective downward-extending tabs 426 on the opposite (outward from the deck center, in the X dimension) sides of covers 412A, 412B that sit flush against the side bottom rails. Each plate defines a downward-facing concave structure to provide adequate clearance for the rear vehicle wheels. In some embodiments, covers 412A, 412B may also slide into openings defined in adjacent cross members 408A, 408B to assist in maintaining the position of covers 412A, 412B. These and any other connections in deck assembly 400 may be made using fasteners such as bolts, rivets, or screws, and such fasteners may be considered part of deck assembly 400.

Each of the deck assembly cross members is formed in a “C” shape cross section in a vertical plane that includes the Z dimension. For most of the cross members, identified in FIG. 4 as 408A, the C shape opens toward the vehicle rear, with the flat back surface of the “C” facing forward and generally planar upper and lower flanges extending rearward from the vertical portion. Two cross members, however, are in the reverse orientation and are referenced as 408B and 408C in FIG. 4. Cross member 408B is immediately aft of steel plate covers 412A and 412B, resulting in a cross member 408A, with its concave cross section opening toward the steel plate covers, forward of the steel plate covers and a cross member 408B, with its concave cross section also opening toward the steel plate covers, rearward of the steel plate covers. This allows the side edges (extending parallel to the X dimension in FIG. 4) of steel plate covers 412A and 412B to be received within the two cross members' concave openings. In one or more embodiments, the broad generally planar side flanges of each steel plate cover on the two sides of the steel plate cover's center ridge have to bend slightly downward to be received in these cross-member concave openings, thus causing those sides to be biased upward against the cross member top flanges. In one or more embodiments, the side edges of the plates are not attached to these cross members by fasteners or welding.

In various embodiments, components of a deck assembly may be hot dip galvanized as individual components, thereby providing corrosion protection to the components, and then attached together using fasteners into the entire, assembled deck assembly, as discussed above and otherwise herein. By hot dip galvanizing individual components and assembling the components after galvanization, rather than hot dip galvanizing an entire, pre-assembled deck assembly, the cost of hot dip galvanization may be reduced. Hot dip galvanizing of an entire, assembled deck assembly requires a vat, for holding liquid galvanization fluid, sufficiently large that the pre-assembled deck assembly may fit within the volume defined by the vat. To the extent a manufacturer's deck assemblies have different shapes or sizes, a galvanization vat would be configured to accommodate that variation when galvanizing an entire, assembled deck assembly.

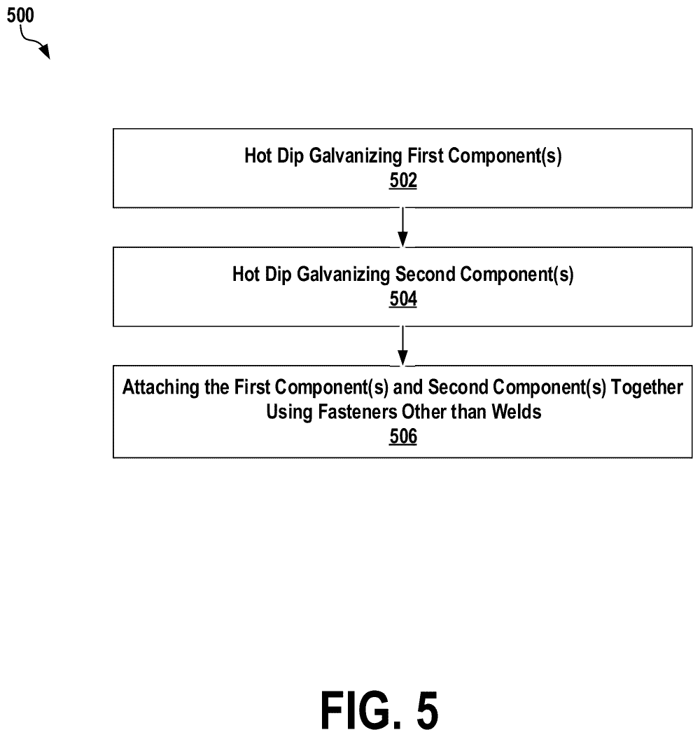

FIG. 5 illustrates one or more example methods contemplated for hot dip galvanization of a deck assembly for a vehicle. At operation 502, a first set of one or more components are hot dip galvanized. With reference to FIGS. 3 and 4, for example, the first set of one or more components may be one or more components of the set of deck assembly 300 components comprising front channel 302, elongated steel bottom beams 306A, 306B, brackets 304A, 304B, cross members 308A, 308B, 308C, and steel plate covers 312A, 312B, or one or more components of the set of deck assembly 400 components comprising front/rear channels 402, 414, elongated steel bottom beams 406A, 406B, brackets 404A, 404B, cross members 408A, 408B, 410, and steel plate covers 412A, 412B. The first set of one or more components may comprise metal material and, in particular, ferrous materials, such as the steel components of deck assembly 300 or deck assembly 400. Hot dip galvanization may be accomplished by placing the first set of one or more components in a vat of a molten material comprising zinc, activating (heating) the vat while the one or more components are submerged in the molten material, removing the one or more components from the molten material and the vat, and allowing the one or more components to cool. Hot dip galvanization may result in deposition of a material comprising zinc to the first set of one or more components to protect against corrosion.

At the end of step 502, the first set of one or more deck assembly components are removed from the galvanization vat and allowed to cool. At operation 504, a second set of one or more deck assembly components (e.g., one or more components of deck assembly 300, where the first set of one or more deck assembly components were components of deck assembly 300, or one or more components of deck assembly 400, where the first set of one or more deck assembly components were components of deck assembly 400), that were not galvanized in the first set of one or more deck assembly components, are hot dip galvanized. The second set of one or more components may also comprise metal material, such as the steel components of deck assembly 300 or deck assembly 400, and the second set of one or more components may be hot dip galvanized in a manner similar to the galvanization of the first set of one or more components. At the end of step 504, the second set of one or more deck assembly components are removed from the galvanization vat and allowed to cool. Additional sets of one or more deck assembly components are, in one or more embodiments, hot dip galvanized until all deck assembly components requiring corrosion protection have been hot dip galvanized. It should be understood that, in one or more embodiments, each deck assembly component, e.g., of deck assembly 300 or deck assembly 400, is galvanized individually. Moreover, it should also be understood that a plurality, but fewer than all, of the individual components, for example of deck assembly 300 or deck assembly 400 above, can be welded or otherwise connected together to thereby form a new individual component, prior to the galvanization step. Thus, such a subassembly of deck assembly components can comprise a single component for galvanization at the above-referenced galvanization steps. Further, it should also be understood that, in one or more embodiments, all of the steel components of the deck assembly are galvanized in the same vat, in a single galvanization step. Because the deck assembly is unassembled, however, the collection of unassembled (with respect to the deck assembly) components require a galvanization vat of lesser volume than would be the case if the deck assembly were fully assembled at the galvanization step.

At operation 506, the first set of one or more deck assembly components are attached to the second set of one or more deck assembly components, e.g. as described above. If there are more than two galvanization steps, then in one or more embodiments the corresponding sets of component(s) are attached together with the first and second sets of component(s), thereby assembling the deck assembly. Attachment is accomplished using fasteners, e.g., by bolts, screws, rivets, or other fasteners, or combinations thereof.

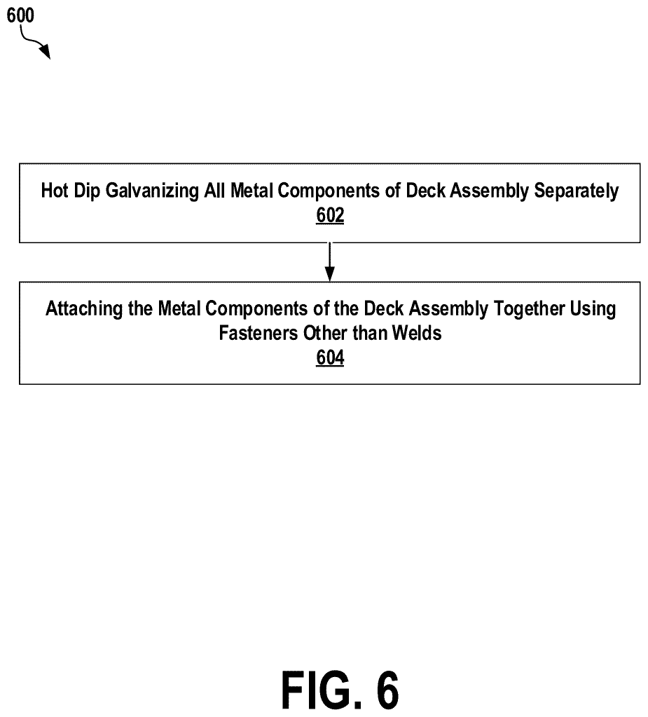

Another approach for hot dip galvanizing a deck assembly of a vehicle is illustrated in the example method 600 of FIG. 6. At operation 602, all metal components of a deck assembly are hot dip galvanized separately. Hot dip galvanization may be accomplished by placing the unassembled (with respect to the deck assembly) steel deck assembly components, individually or in one or more groups, in a vat and activating the vat to perform hot dip galvanization. Hot dip galvanization may result in deposition of a material comprising zinc to the first set of one or more components to protect against corrosion. At operation 604, the deck assembly is assembled. As part of that process, the now-galvanized steel bottom beams (see 306A, 306B, 406A, and 406B, FIGS. 3 and 4) are disposed parallel to each other and spaced apart by the distance of the longitudinal box beams of chassis frame 14, as discussed above. Each of the cross members (sec 308A, 308B, 308C, 310, 408A, 408B, and 410, FIGS. 3 and 4) is disposed at the desired longitudinal position on the bottom beams (see, e.g., the arrangements at FIGS. 3 and 4) and with its dimension of elongation generally perpendicular to the dimension of elongation of the bottom beams. In one or more embodiments, the cross-members' bottom “C” flanges have a plurality of through holes that are spaced apart so that a pair of through holes in each cross-member's bottom flange aligns with a corresponding pair of through holes (one each) in the top “C” flanges of the two bottom beams.

Because the deck assembly is assembled without pre-welding of the now-galvanized components, the deck assembly components are constructed to facilitate assembly in a production process. Thus, for example in one or more embodiments, the deck assembly bottom beams are “C”-shaped, rather than I beams, thereby facilitating attachment of the bottom beams to the C beams of chassis frame 14 by the vertical brackets that sit flush against the backs of the “C”-shaped bottom beams and the sides of the chassis C beams, which are generally planarly aligned with each other. Also, in one or more embodiments, the deck assembly cross members are “C” shaped to provide the horizontal flanges through which the cross members can be attached by fasteners to the bottom beams. And, in that regard, the holes in the top and bottom flanges are the same size (such that there is no single correct orientation for the cross member) with a diameter large enough to admit both the fastener and a driver thereof, such as a bit or socket at the end of an extension of a drill or robotic arm, but small enough that a lock washer between the bolt head and the flange around the through hole is wider than the hole so as to retain the bolt against the C flange. Thus, in the assembly step, once the bottom beams are positioned in their spaced apart orientation and the cross member is laid across them with its flange holes aligned with the through holes in the top flange of the bottom beams, a bolt body may be inserted from above through the aligned holes in the bottom flange of the cross member and the top flange of the bottom beam until the bolt head (or bolt head/lock washer) rests against the cross member flange surrounding the holes and the body extends through both holes. The operator, or a robot, reaches into the open concave channel of the bottom beam and places a nut and washer over the threaded distal end of the bolt and rotationally secures the nut. The operator, or a robot, then inserts the driver down through the hole in the top of the cross member's top flange that aligns with the hole in the cross member's bottom flange in which the bolt is positioned until the driver's bit or socket engages the bolt head. The operator, or a robot, actuates the driver while rotationally holding the nut, thereby driving the bolt and nut toward each other and sandwiching the flanges of the cross member and bottom beam together, thereby securing the cross member to the bottom beam. Alternatively, the driver may be inserted through the bottom beam bottom flange to rotationally drive the nut while the bolt head is rotationally secured from above. It will also be understood, in view of the present disclosure, that the bolt could be inserted from the bottom beam channel, up through the aligned holes of the bottom beam flange and the cross member flange, to receive the nut in the cross member channel, reversing the orientation, and that the driver may, in such embodiments, be inserted through the lower flange of the bottom beam, while the nut is rotationally secured from above, or that the driver may be inserted from above to drive the nut while the bolt head is rotationally secured below. This process is repeated for the same cross member at the opposing bottom beam.

This is then repeated for all the remaining cross members. Referring to the embodiments at FIGS. 3 and 4, cross members 310, 410 have end tabs 324, 424 that are, when steel plate covers 312, 412 are put in position such that their top ridges face upward and the ends of their downwardly depending side flanges are received in corresponding concave openings of the adjacent cross members as discussed above, aligned with corresponding tabs 326, 426 that bend down from the plates. Tabs 324, 424 may have through holes that align with through holes in tabs 326, 426. Bolts or rivets are pushed through the aligned holes and secured by a nut or rivet step, or by use of other types of fasteners. Each of the steel channel members (see 302, 304, 402, and 414, FIGS. 3 and 4) are assembled to deck assembly bottom rails as described above, each with its dimension of elongation generally perpendicular to the dimension of elongation of the bottom beams.

Referring also to FIGS. 1 and 2, step 604 may also encompass the assembly of cargo compartment body 18. The deck assembly cross members have tabs (see 328, 428 in FIGS. 3 and 4) that rest flush against vertical inner surfaces of the cargo body's aluminum bottom rails (see 40, FIG. 1). The bottom rails may have through holes that align with through holes in tabs 328, 428. Bolts or rivets are pushed through the aligned holes and secured by a nut or rivet step, thereby securing the deck assembly to the cargo body. Floor 30, e.g., may comprise planking or sheets of wood, polymer, aluminum, or other material mounted to and over the decking assembly cross members, secured directly thereto in the case of a dry freight vehicle or secured thereto via composite sills with intervening foam in the case of a refrigerated trailer. Front wall 32, rear wall 33, and two opposing side walls 36 are attached to bottom rails 40, the front bottom rail (not shown), the rear bottom rail (not shown), front vertical posts 42, rear vertical posts 48, side top rails 38, front top rail 44, and rear top rail 50, as discussed above. Roof 34 is attached to front vertical posts 42, rear vertical posts 48, side top rails 38, front top rail 44, and rear top rail 50, as discussed above. Also as discussed above, the rear wall panel may attach to the rear frame, comprised of vertical rear posts 48, rear top rail 50, and the rear bottom rail. The rear wall panel may be continuous or may define one or more openings that receive and enclose one or more rear doors (not shown) of a size, and being hingedly attached to the rear panel or the rear vertical posts, so that, when closed, the rear panel and doors completely close the space bounded by the rear frame and thus enclose the enclosed cargo volume defined by floor 30, side walls 36 (and its doors, if any), rear wall 33 (and its doors, if any), and roof 34. The floor, roof, front wall, side walls, rear wall, associated doors, and the cargo box frame components discussed herein comprise the cargo body box that is mounted on chassis frame 14 rearward of vehicle driver cab body 16.

Before or after the assembly of the box of body 18, brackets (304A, 304B, 404A, 404B in the examples of FIGS. 3 and 4) are disposed flush against the sides of bottom beams (306A, 306B, 406A, 406B0 and the sides of chassis frame 14 (FIG. 1), as discussed above, so that through holes in the top of the brackets align with through holes in the vertical part of the “C” of the bottom beams and so that through holes in the bottom of the brackets align with through holes in the sides of the chassis frame. Bolts or rivets are pushed through the aligned holes between the brackets and the bottom beams and between the brackets and the chassis frame, and secured by a nut or rivet step, thereby securing the deck assembly to the chassis frame.

Accordingly, as reflected above, the galvanized metal components of the deck assembly are attached together, and to other vehicle components, without welding, using fasteners that extend through or otherwise into the components.

In methods 500 and 600, other operations may be performed before and after hot dip galvanization. For example, metal components may undergo degreasing before hot dip galvanization to remove residual grease, dirt, oil, and other unwanted materials; metal components may undergo pickling to remove iron oxide and other impurities; metal components may undergo fluxing to coat metal components with a protective layer to avoid oxide formation prior to hot dip galvanization; and metal components may undergo other rinsing, cooling, and/or drying operations. Other operations may also be added without departing from the scope of the invention.

While different methods have been described herein, these methods may be modified in other embodiments. Certain operations may be added or omitted in some embodiments. For example, in method 500, additional sets of one or more components may be hot dip galvanized and then assembled with other sets of component(s).

While one or more preferred embodiments of the invention are described above, it should be appreciated by those skilled in the art that various modifications and variations can be made in the present invention without departing from the scope and spirit thereof. For example, alternate embodiments of composite panels in accordance with the present disclosure may have fewer, or more, layers than the number of the discussed embodiments. It is intended that the present invention cover such modifications and variations as come within the scope and spirit of the appended claims and their equivalents.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A deck assembly for a vehicle, the deck assembly being formed by a process comprising:
hot dip galvanizing a first component, the first component comprising metal;
hot dip galvanizing a second component, the second component comprising metal; and
attaching the first component and the second component together using fasteners,
wherein the first component and the second component are not attached together via welds.

2. The deck assembly of claim 1, wherein the hot dip galvanizing of the first component and the hot dip galvanizing of the second component result in deposition of a material comprising zinc onto the first component and the second component.

3. The deck assembly of claim 1, wherein the deck assembly comprises:
a plurality of elongated beams having a dimension of elongation generally parallel to a front-to-back dimension of the vehicle; and
a plurality of cross members, each defining a dimension of elongation generally transverse to the dimension of elongation of the plurality of elongated beams.

4. The deck assembly of claim 3, wherein the deck assembly further comprises:
a first end frame,
wherein the plurality of beams are attached to the first end frame.

5. A method of manufacturing a vehicle, comprising the steps of:
providing a vehicle chassis frame, a plurality of front wheels and a plurality of rear wheels disposed on the chassis frame via a suspension, a drive train mounted on the chassis frame and operatively attached to the rear wheels, and a driver cab disposed on a forward end of the chassis frame;
hot dip galvanizing a plurality of components of a deck assembly of a cargo body comprising at least one cross member and at least one longitudinal member transverse to the at least one cross member, wherein the components of the plurality of components are unattached with respect to each other during the step of hot dip galvanizing the plurality of components;
following the hot dip galvanizing step and in a step of assembling the deck assembly, attaching the components of the plurality of components into the deck assembly with fasteners that extend through or into the components of the plurality of components;
assembling the deck assembly onto the vehicle chassis frame rearward of the driver cab; and
assembling the cargo body onto the deck assembly, where the cargo body comprises a plurality of walls, a roof, and a floor, and wherein the floor is mounted onto the deck assembly.

6. The method of claim 5, wherein
at the hot dip galvanizing step, the plurality of components of the deck assembly comprises a plurality of elongated beams, each having a dimension of elongation, and a plurality of cross members, each having a dimension of elongation,
at the step of assembling the deck assembly onto the vehicle chassis frame, the dimension of elongation of the elongated beams is generally parallel to a front-to-back dimension of the vehicle chassis frame, and
at the step of assembling the deck assembly, the dimension of elongation of the cross members is generally transverse to the dimension of elongation of the plurality of elongated beams.

7. The method of claim 6, wherein at the step of assembling the deck assembly
the deck assembly further comprises a first end frame, and
the plurality of beams are attached to the first end frame.

8. The truck body of claim 6, wherein, at the hot dip galvanizing step, all elongated beams and all cross members of the deck assembly are hot dip galvanized separately from each other.

9. A method for manufacturing a deck assembly for a vehicle, method comprising:
hot dip galvanizing a first component, the first component comprising metal;
hot dip galvanizing a second component, the second component comprising metal; and
attaching the first component and the second component together using fasteners,
wherein the first component and the second component are not attached together via welds.

10. The method of claim 9, wherein the hot dip galvanizing of the first component and the hot dip galvanizing of the second component result in deposition of a material comprising zinc onto the first component and the second component.

11. The method of claim 9, wherein all metal components of the deck assembly are hot dip galvanized separately, all metal components of the deck assembly are attached together using fasteners other than welds.
